(19) United States
(12) Patent Application Publication
(10) Pub. No.: US 2011/0294095 A1
(43) Pub. Date: Dec. 1, 2011

(54) TOOTH STUMP STRUCTURE, PRODUCTION METHOD AND DESIGN THEREOF

(75) Inventors: Josef Jancár, Brno (CZ); Zbynek Sedivý, Brno (CZ)

(73) Assignee: ADM a.s., Brno (CZ)

(21) Appl. No.: 13/147,982

(22) PCT Filed: Jan. 7, 2010
(86) PCT No.: PCT/CZ2010/000001

§ 371 Date: Aug. 4, 2011

(30) Foreign Application Priority Data
Feb. 18, 2009 (CZ) PV 2009-93

(51) Int. Cl. A61C 13/09; A61C 5/11; A61C 13/087

(52) U.S. Cl. 433/206; 433/212.1; 433/219

(57) ABSTRACT

A method for producing a tooth stump structure that is to be anchored in a root canal comprises the following steps: flexible needles are introduced one after the other into a recess in the form of a root canal or into an exposed cavity; the length of the protruding ends of the needles is adjusted to the form of a core of the stump structure, the core is then modelled from a semi-liquid, polymerizable composition and subsequently hardened; and an outer jacket of a crown is applied to the core. The tooth stump structure produced by said method is formed by a structural core made of a hardened composition, wherein individual flexible needles are anchored in said core and protrude therefrom, a cross section of the needles being circular, elliptical or polygonal and their diameter ranging from 0.1 to 0.8 mm. The protruding parts of the needles occupy a space that corresponds essentially to the space of the root canal or the cavity.

### TECHNICAL FIELD

The invention concerns the method of making a tooth stump structure anchored in a root canal and a stump structure made in this way.

### PRIOR ART

For the purpose of endodontic tooth treatment practical dentists use metal or composite pins anchored in a cylindrical cavity resulting from predrilling of a root canal. Their disadvantage is represented by the fact that they negatively affect appearance of the reconstructed tooth, being a foreign element in the tooth pulp with a higher elasticity module, with a consequence of the vertical component of the force acting on the artificial crown being transferred onto the canal walls. This may lead to the roof fracture as the root is is already weakened by the canal widening. From this point of view pins of composite materials are more convenient. Composite pins are made of differently configured bundles of glass or carbon fibre in resin matrix.

Patent document U.S. Pat. No. 6,267,597 introduces a method of orthodontic tooth reconstruction characterized in that a pin is made of non-hardened or partially hardened composite containing polymeric matrix and reinforcing fibres. The bottom end of the pin is melted to acquire the shape of the roof canal cavity in which it is to be inserted. Then the pin is hardened and a stump for the crown is formed on its top onto which the crown is subsequently applied. The advantage of this solution is represented by the fact that it is not necessary to widen the root canal, which just needs to be cleaned. General widespread use of this method is limited by the fact that it is very difficult to insert a composite pin in the narrow cavity of the root canal.

Patent documents U.S. Pat. No. 5,741,139 and U.S. Pat. No. 6,371,763 describe the pin as part of the stump made of a composite material with fibres, at least one of which is not parallel to the tooth canal axis. The fibres can be arranged into different configurations in the composite pin such as twisted, convergent, in a grid or scattered. The industrially manufactured pin in an adhesive case is applied into the tooth canal. A metal disc as the basis for the stump is fixed to the protruding end of the pin, which may be additionally frayed. The disadvantage of this pin type is represented by the fact that like in the previous case the insertion of the pin in the narrow cavity of the root canal is difficult.

If a practical dentist needs to make a tooth stump with a sufficient part of the original crown at hand the stump is connected to the remaining tooth tissue with an adhesive joint. However, this connection is very susceptible to fracture.

The present invention aims at designing a tooth stump system transferring the loads resulting from chewing onto the root in the same way as in the case of a healthy tooth. The treatment will not damage the root and will provide for a firm connection of the pulp and the stump. The system is easy to use in practical dental surgeries.

### SUMMARY OF THE INVENTION

The purpose of the invention was to find a method of making a tooth stump by its anchoring in a root canal characterised in that flexible needles are inserted in a cavity in the shape of a root canal or to a prepared recess one by one, with the length of the protruding ends of the needles adjusted to the shape of a core of the stump. The core of the stump is then modelled of semi-liquid polymer composite and hardened for subsequent application of an outer jacket of a crown.

In the preferable embodiment of the invention the needles are inserted in the canal or cavity until it is filled up.

For increased resistance the surface of the stump core may be treated with two-dimensional metal, ceramic, polymer or composite reinforcement.

The tooth stump made in the above described manner comprises a stump core of hardened polymer composite with protruding separate flexible needles anchored in it. A cross section of the needles is circular, oval or polygonal with a circumference diameter of the cross section ranging from 0.1 to 0.8 mm, protruding parts of the needles virtually filling up a space corresponding to the root canal or cavity size.

The needle as part of the tooth stump can be made of metal, ceramic, polymer or composite, with circular, oval or polygonal shape with the circumference diameter ranging from 0.1 to 0.8 mm. The needle cross section can vary across the needle length.

### BRIEF DESCRIPTION OF THE DRAWINGS

The invention will further be described with the help of a drawing where two different embodiments of the tooth stump are shown in their cross sections.

FIG. 1 is a tooth stump for endodontic tooth treatment.

FIG. 2 is the same stump applied onto a model on which it was made.

FIG. 3 is the stump provided with two-dimensional reinforcement.

FIG. 4 is another embodiment of the stump for application onto a cavity.

FIG. 5 is the stump according to FIG. 4 applied onto a model.

### DETAILED DESCRIPTION OF PREFERRED EMBODIMENTS

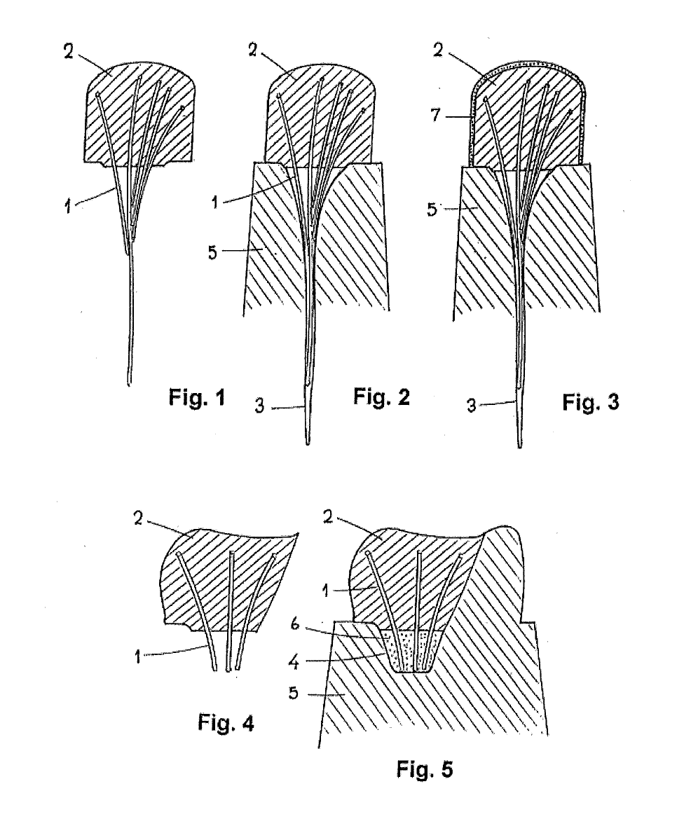

The basic element of a tooth stump embodiments according to FIGS. 1 to 5 is a flexible needle 1 with circular cross section with the diameter of 0.45 mm, whose original non-truncated length is 20 mm. The needle is formed of a bundle of glass fibres in hardened resin matrix with constant cross section across its length. In other embodiments the needle 1 cross section may be oval or polygonal with the largest diameter of 0.1 to 0.8 mm. The needle 1 may be made of metal, ceramic or polymer. In other embodiments the cross section of the needle may change across its length.

A tooth stump in the embodiments pursuant to FIGS. 1 to 5 consists of a stump core 2 of hardened polymer composite with protruding separate flexible needles 1 anchored in it. The cross section of the needles is circular and the diameter is 0.45 mm. The protruding ends of the needles 1 in fact occupy a space corresponding to the size of a root canal 3 or cavity 4.

The method of making the tooth stump is shown in FIGS. 2 and 5. The needles 1 are inserted one by one into a cavity in the shape of a root canal 3 or a prepared cavity 4 in a model 5, i.e. ex vivo. In the case of the stump according to FIG. 2 the needles are inserted in the root canal 3 until it is filled up. If a cavity 4 is to be treated, it is first filled with a soft matter 6, such as polystyrene, in which the needles 1 are provisionally fixed. The protruding ends of the individual needles 1 are shortened to fill the space designed for the stump core 2. Subsequently the stump core 2 is modelled in this space of semi- liquid polymer composite, hardened and used for application of the outer jacket of the crown. In the embodiment according to FIG. 3 the stump core 2 is provided with two-dimensional reinforcement 7 on the surface in the form of a mesh of composite material comprising woven glass fibres in non-hardened resin matrix. After the reinforcement 7 application on the surface of the core 2 the reinforcement 7 is hardened. In other embodiments the reinforcement 7 may however also be made of metal, ceramic or polymer. The outer jacket of the stump is then applied onto the core 2. The thus made stump is subsequently applied in vivo on the prepared remaining part of the tooth of the patient, i.e. the bundle of the protruding needles 1 is inserted in the root canal 3 prefilled with adhesive that can subsequently be hardened. Also the core 2 is glued to the upper surface of the tooth. This, however, is no longer the subject of the present invention.

1. A method of making a tooth stump anchored in a root canal, wherein flexible needles are inserted one by one into a cavity in the shape of a root canal or into a prepared cavity, the length of protruding ends of the needles being adjusted to the shape of a stump core, subsequently modelled of semi-liquid polymer composite and hardened for an outer jacket of a crown to be applied onto it.

2. The method according to claim 1, wherein the needles are inserted into the canal or cavity until it is filled up.

3. The method according to claim 1, wherein the surface of the stump core is treated with two-dimensional reinforcement of metal, ceramic, polymer or composite.

4. A tooth stump anchored in a root canal and comprising a stump core of hardened polymer composite, wherein separate flexible needles protrude from the core, anchored in it, a cross section of the needles being circular, oval or polygonal and a diameter of their circumference ranging from 0.1 to 0.8 mm, protruding ends of the needles virtually filling up a space corresponding to the size of the root canal or prepared cavity.

5. The tooth stump according to claim 4, wherein the needles are made of metal, ceramic, polymer or composite, with a circular, oval or polygonal cross section whose circumference diameter ranges from 0.1 to 0.8 mm.

6. The tooth stump according to claim 5, wherein the needle cross section may vary across its length.
